(19) United States
(12) Patent Application Publication
(10) Pub. No.: US 2003/0075500 A1
(43) Pub. Date: Apr. 24, 2003

(54) Filter element

(76) Inventors: Lars Kleingünther, (US); Ingo Kleingünther, Dresden (DE); Frank Jacobi, Dresden (DE)

Correspondence Address: VENABLE, BAETJER, HOWARD AND CIVILETTI, LLP, P.O. BOX 34385, WASHINGTON, DC, 20043-9998, US

(21) Appl. No.: 10/168,631

(22) PCT Filed: Dec. 22, 2000
(86) PCT No.: PCT/EP00/13171

(30) Foreign Application Priority Data
Dec. 22, 1999 (DE) 199 62 261.2

(51) Int. Cl. B01D 29/07

(52) U.S. Cl. 210/493.1; 210/483; 55/490; 55/521; 95/273

(57) ABSTRACT

A filter element (31) of a fluid filter, in particular of a cuboid or hollow-cylindrical outer shape, having an inflow side (A) and an outflow side (B) relative to a fluid to be filtered, with the filter element (31) comprising a number of pleat walls (35) each arranged in a continuous folding between pleat edges (35A; 35B), which pleat walls are comprised of a fluid-permeable filter material, in particular having impressed elevations (37) constituting depressions on the other side of the filter material, and wherein between adjacent pleat walls in each case on the inflow side (A), aggregates of hardened adhesive are provided on said elevations (37) adhering to the pleat walls, wherein on the outflow side (B) and/or the inflow side (A) supporting elements are provided, the projection of which onto the plane of the adjacent pleat wall is situated in each case at least section-wise within the depressions.

The invention relates to a filter element of a fluid filter according to the preamble of claim 1.

Filter elements of that type are known and are in practical use, in particular as air filters for internal combustion machines and in industrial plants.

At present, filter elements are preponderantly used in air filters which comprise a fiber fleece, in particular of glass fibers, cellulose fibers or synthetic fibers.

So as to increase the actual filter surface relative to the inflow surface of the filter (cross-sectional surface of the inlet opening), the filter medium is folded in a known manner in a meander shape into essentially parallel pleat walls. Thus, a “pack” of pleats somewhat bent in the plane is created, which pleats border each other via pleat edges. These pleats are approached by the medium to be purified in the inflow zone in a small and, due to the curvature, not exactly defined angle relative to the walls of the folding, and thereby transversely to the direction of the pleat edges.

Due to the irregularity of the pleat structure, material deposits—in particular also larger particles deposits—at the inflow side of the filter, and vortex formations in the inflowing fluid etc., inhomogenities of the fluid flow arise, with the filter being flowed through exposing the pleat arrangement to a considerable mechanical alternating stress.

In filters having a major pleat height, it has been usual for a longer time to impress depressions into the filter material, which depressions have an alternating orientation and a form predetermined in such a manner that during folding of the material, the depressions of adjacent pleat walls come into abutment against and mutually support each other, so that a stabilization of the configuration is achieved. The form of the impressions may be predetermined in such a manner that a zigzag folding arises having plane pleat walls; cf. U.S. Pat. No. 3,531,920. An adhesive may in addition be applied onto the impressions causing area-wise a firm adhesion of the pleat walls during folding, and hence a further reinforcement; cf. e.g. DE 41 26 126 A1.

It is also known from DE 40 38 966 A1 to place semi-spherical spacers onto the pleat walls or to insert them into same. These spacers may be—as mentioned as one possibility in the document cited above—adhesive aggregates, in particular in thread form. Apart from the spacing effect, these spacers moreover have an effect of connecting the pleat walls and thus additionally increase the rigidity of the filter element.

The document DE 39 03 730 A1 describes that an adhesive thread interconnecting and stabilizing the pleat layers which may be applied to the edge zone after folding, is combined with impressions in the pleat walls. This solution, as well, results in mechanically relatively stable filter elements, but is laborious in terms of technology.

From the document EP 0 377 419 A1, an arrangement is known, in which due to adhesive aggregates localized in the top as well as the bottom zone of a pleat wall arrangement to be formed, which are superposed in a double layer in the top zone but are only present in a single layer in the bottom zone, a bilateral bonding in each case at certain points of pleat walls is realized.

For filters having very high pleat heights, a combination of impressions and in addition, distance-extending adhesive aggregates are proposed in the document WO 95/17943. Here, as well, the pleat walls preferably are bonded on both sides of their elevations with the respective adjacent pleat wall. Since the elevations always protrude alternatingly from the opposite surfaces of the pleat wall, the bonding zones of the individual pleat wall surfaces mutually keep relatively large distances.

Air filters for certain types of internal combustion machines, e.g. for gas turbines, must be able to withstand relatively high alternating pressure loads—of typically up to 40 times the normal pressure difference between the inflow and outflow side of the filter—according to the specifications in vigor.

The known filter elements only comply with these requirements in a restricted manner; with high and long-lasting alternating pressure loads, the adhesive threads start detaching from the filter material on the inflow side, so that the stability of the filter elements first gets lost locally, and a complete destruction of the filter element may follow.

The invention is therefore based on the object of proposing an improved filter element of the generic kind, which in particular distinguishes by a considerably increased resistance against alternating pressure stress.

This task is solved by a filter element having the features of claim 1.

The invention embraces the essential idea of providing, in a lateral alignment with the spacers on the inflow side of an essentially zigzag-shaped filter material folding (in which the pleat cross-section hence is essentially V-shaped), rear-side supporting elements. The spacers and the supporting elements (the designation of which has here been selected for terminological distinction, but which, of course, have likewise a spacer function) may be directly applied on the plane pleat wall, in each case having an increasing height in filters having a small pleat height, the so-called “minipleats”.

Preferably, and technologically particularly remarkable, is the configuration in pre-impressed pleat walls, wherein the impression of the filter material web is realized in such a manner that elevations form towards the inflow side. The supporting elements, in a simple and appropriate configuration, are inserted rear-side as adhesive aggregates, in particular adhesive threads, into the depressions of the impressions of the filter material.

In a preferred embodiment, the basis or projection of the supporting elements to the plane of the pleat walls, is essentially arranged completely within the projection of the spacers on the other surface, in particular entirely within impressed depressions, which protrude from the opposite surface of the pleat walls as elevations. Hence, that surface zone of the depressions/elevations impressed into the filter material are exclusively used for the mutual support of the pleat walls. Those filter material surfaces which are situated outside from the impressions hence remain free from supporting elements and constitute filter-active zones with their entire surface.

In a technologically successful and cost-efficient and consequently advantageous configuration, the supporting elements are formed of a hardened adhesive, in particular of a hot-melt adhesive, in such a manner that they fixedly adhere to the respectively interconnected surfaces. For this purpose, the adhesive is applied onto at least one of the two surfaces, and the other is brought into contact with the adhesive aggregate before hardening, or the surfaces facing each other after folding are both provided with adhesive and brought closer to each other such that the adhesive aggregates interconnect in the unhardened state.

In a realization deviating herefrom, prefabricated spacers are inserted in the pleat wall depressions, with these, as well, being preferably fixed at least with adhesive.

A particularly highly stress-resistible and reliable support and connection of the pleat walls may be achieved with elongated adhesive aggregates and supporting elements, respectively, which extend on or in the elevations/depressions over a large part of the lengths thereof—preferably over the entire lengths thereof.

The selectively provided elevations and depressions, respectively, can be produced in a particularly simple manner, when they exhibit an essentially constant height in the direction perpendicular to the pleat edges. In this configuration, as well as in the variant without impressions, the V-shaped cross-section between the pleat walls adjacent to each other is taken into account in that the supporting elements and the adhesive aggregates, respectively, are created and applied, respectively, having a non-constant height in the longitudinal direction of the filter material. Of a particularly simple producibility is in this case an embodiment having continuous impressed beads for the realization of the elevations/depressions.

Alternatively to the above-mentioned configuration having elongated spacers and supporting elements (adhesive aggregates), respectively, these are of a spatially limited, quasi “point-wise” configuration. Here, as well, the combination having impressed elevations/depressions of constant heights is possible, with the varying spacing between adjacent pleat walls in the V-shaped cross-section of the folding being taken into account by a varying height of these quasi point-wise spacers and supporting elements, respectively. In this realization, the filter-active material surface is even larger than with the realization of the elongated supporting elements. The resistance against alternating pressures, however, tends to be somewhat lower, since smaller contact faces are used for connecting the pleat walls.

Advantages and functionalities of the invention moreover result from the subclaims and the following description of preferred exemplary embodiments by means of the Figures. Therein shows:

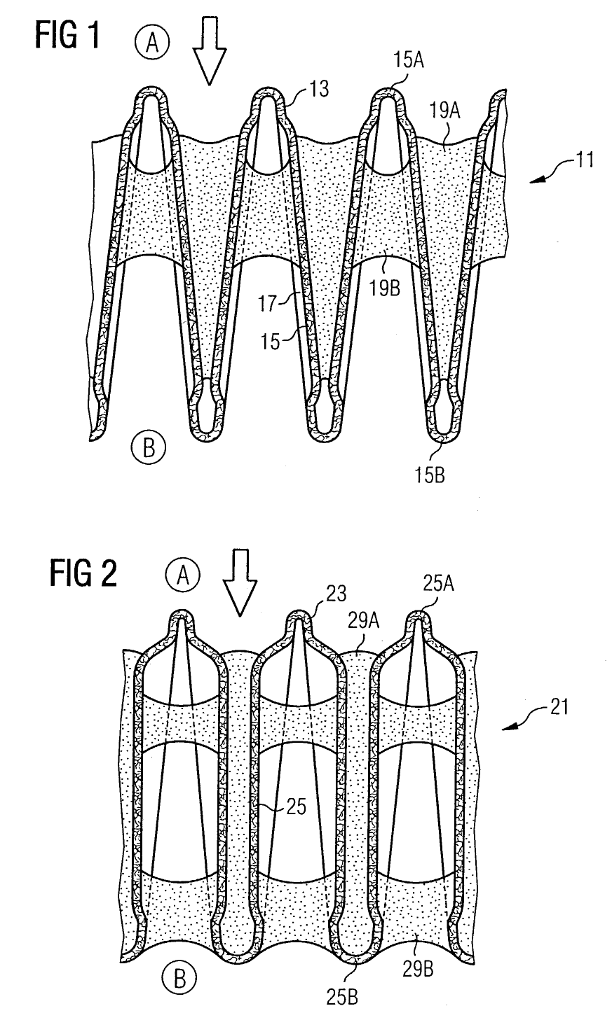

FIG. 1 an illustration in a longitudinal cut (cutout) of a filter element according to a first embodiment of the invention,

FIG. 2 an illustration in a longitudinal cut (cutout) of a filter element according to a second embodiment of the invention,

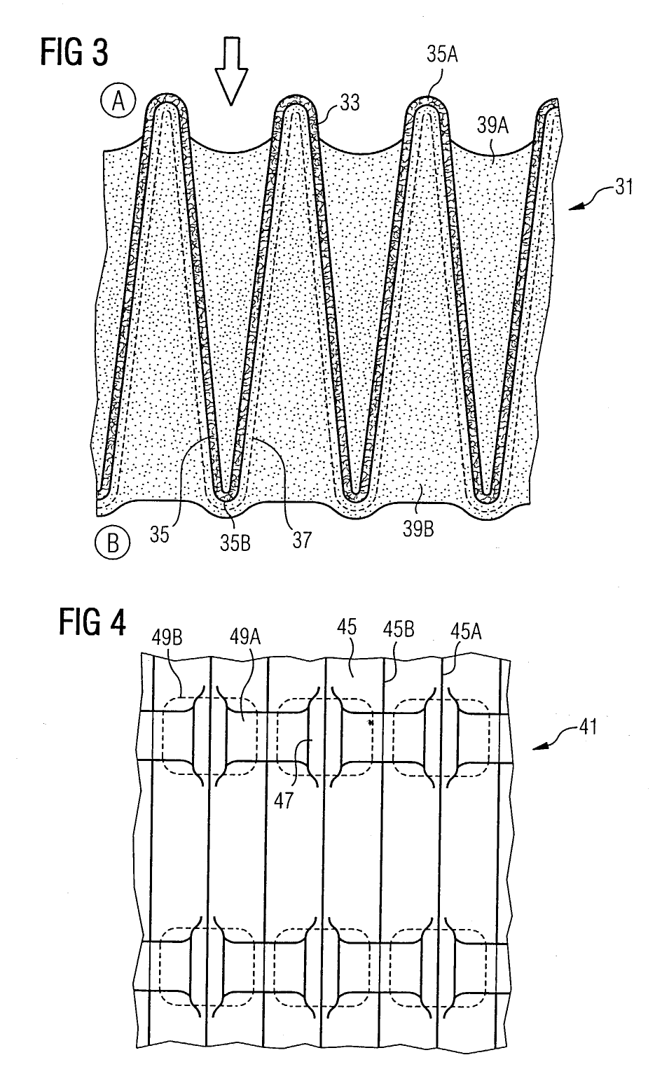

FIG. 3 an illustration in a longitudinal cut (cutout) of a filter element according to a third embodiment of the invention,

FIG. 4 a top view (cutout) of an embodiment of a filter element intended to illustrate the corresponding arrangement of spacer and supporting elements, respectively, on the inflow and the outflow side,

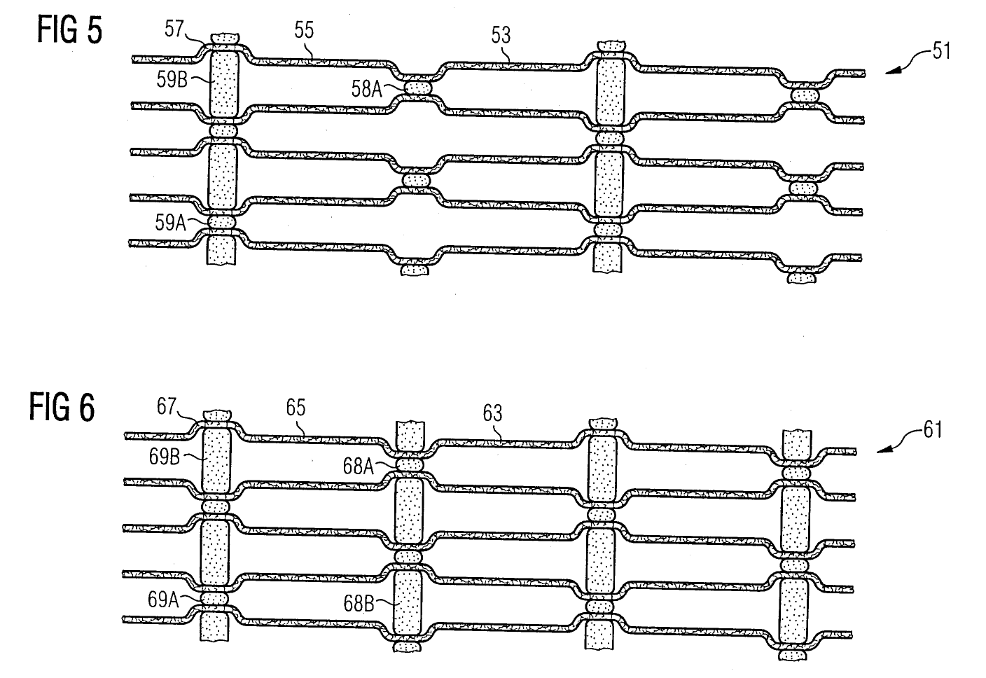

FIG. 5 a schematic cross-sectional illustration (cutout) along a section plane in parallel to the pleat edges of an embodiment of a filter element, and

FIG. 6 a schematic cross-sectional illustration (cutout) of a filter element according to a further embodiment.

FIG. 1 shows in a longitudinal cut a cutout of a filter element (“filter pack”) in a zigzag-shaped folding of a filter material fleece 13, comprising in each case on an inflow side A and an outflow side B a regular arrangement of pleat edges 15a and 15b, respectively, between which extend pleat walls 15 that are essentially plane and in an acute angle relative to each other.

Into that zone of the filter material constituting the plane pleat walls 15 in the folded condition shown in FIG. 1, flat elongated elevations 17 are impressed, which in the top view (not shown) have an essentially rectangular shape and an essentially elongated trapezoidal cross-section. The impressions appearing on a surface of the pleat walls 15 as elevation 17, of course constitute depressions if viewed from the other surface of the pleat wall.

Between the elevations 17 facing each other, adhesive aggregates 19A of hardened hot-melt adhesive are inserted extending over the entire length of the elevations 17. The aggregates have, as can be seen in FIG. 1, a V-shaped cross-section following the cross-sectional form of the pleats and interconnect the elevations 17 and support them against each other. Immediately on the opposite side of the filter web 13, second, considerably shorter adhesive aggregates 19B are provided between the pleat walls 15—to be more precise, between the elevations 17 appearing here as depressions—which are likewise formed of hardened hot-melt adhesive fixedly adhering to the filter material. The adhesive aggregates 19B support the pleat walls 15 on the rear side (outflow side) against each other, and form as a whole with the inflow-side first adhesive aggregates 19A, with which they are aligned over the width of the filter material, fixation zones, which do not allow filter material to detach even under high alternating pressure stress, and hence constitute highly stable and long-life filter elements. The mutually aligned arrangement of the adhesive aggregates on both sides of the pleat walls moreover results in a minimization of the surface covered with adhesive (the non filter-active surface), and thus to a maximization of the filter-active surface.

In FIG. 2, a filter pack 21 is outlined as a further embodiment, with the essential parts or zones being designated with reference numerals in accordance with FIG. 1 and being not explained again here. When comparing the two Figures, it can be recognized that in the filter pack 21 as per FIG. 2, the impressed elevations 27 of the filter material 23 have a larger and non-constant height increasing towards the inside of the opening zone of the pleat walls 25. This results in that the first adhesive aggregates (adhesive threads) 29A running over the entire length of the elevations 27 have on the inflow side A an essentially constant and comparably small height. These can therefore be produced with conventional adhesive application modules without the discharged amount of adhesive being time-controlled.

The second adhesive aggregates 29B, as well, which are arranged on the outflow side B of the filter fleece 23 in depressions corresponding to the elevations 27 as narrowly localized adhesive matter points, can be produced with such “uncontrolled” adhesive application modules. In the outlined realization, an adhesive aggregate of this kind is arranged in each pleat close to the pleat edges 25A and 25B. All pleat walls hence are doubly supported on the outflow side whereby the stability further increases as compared to the arrangement outlined in FIG. 1.

A third embodiment of a filter element 31 is illustrated in FIG. 3. Here, the filter material 33 features continuous, relatively flat beads 37 for reinforcement. The constant height thereof requires the creation of the inflow-side first adhesive aggregates 39A, as well as of the outflow-side second adhesive aggregates 39B having a height increasing according to the pleat cross-section. In these embodiments, the adhesive aggregates on both sides of the filter material are virtually continuous throughout the entire pleat wall, a fact which practically completely prevents local vibration peaks from arising on the pleat wall surface upon alternating pressure stress. The filter element 31 hence is able, although at the price of a high adhesive consumption and the use of controlled adhesive application modules having a non-constant adhesive discharge amount per time unit, to cope with the difficult operation in gas turbines or similar fluidic engines imparting high alternating pressure loads.

In the FIGS. 1 through 3, the adhesive aggregates are essentially outlined having concave contours, depending on the specific process control and adhesive properties, however, the boundaries thereof can also be essentially rectilinear or rather bulged. In the bottom part of FIG. 3, an adhesive application is illustrated overlapping the pleat edges; such an adhesive application can also be provided in the upper pleat edge zone of said filter element, as well as in the arrangements as per FIGS. 1 or 2.

In FIG. 4, a filter element designated with the reference numeral 41 is outlined in a cutout representation in a top view on the outflow-side pleat edges 45A, so as to demonstrate the preferred arrangement of the first 49A and second 49B adhesive aggregates in the side direction. Hereby, the specific shape thereof in the top view is not of importance, rather it is important that the inflow-side, as well as the outflow-side adhesive aggregates essentially are located on or under impressed elevations 47. The outflow-side support hence ensues in the same spatial zones of the filter as the inflow-side connection and spacing. As already mentioned above, the occurrence of transversal and longitudinal vibrations is thus prevented, for one, and it is secured, for another, that the filter surface covered with adhesive, is minimized, i.e. that the remaining filter-active surface is maximized.

The FIGS. 5 and 6 illustrate in cross-sectional representations the fundamental inventive aspect of the lateral alignment of spacers and supporting elements by means of a cutout representation of filter elements 51 and 61, respectively. The selection of the reference numerals follows the previous Figures, that is, numeral 53 or 63 designates the filter material, numeral 55 or 65 designates a pleat wall, and numeral 57 or 67 designates an impression into same, which, in each case depending on the direction of view, represents itself as an elevation or depression.

In the filter element 51 as per FIG. 5, each second spacer 59A—viewed in the latitudinal direction of the filter element—has assigned a “rear-side” supporting element 59B. Whereas in the zone of the spacers 58A situated in between, no supporting element is inserted into the corresponding depression 57 of pleat wall 55. However, in the filter element 61 as per FIG. 6, all adhesive lines are in each case realized on both sides of the pleat walls, i.e. the spacers 69A, as well as the spacers 68A situated in between each have assigned a rear-side supporting element 69B and 68B, respectively. Thus, an inflow-side and outflow-side support is provided for achieving a maximum resistance against alternating pressure as well as a long-term stability.

The realization of the invention is not restricted to the examples described here, but is also possible in a plurality of modifications within the scope of the skilled person's activities.

In particular, it is not bound to the use or the sole use of adhesive, in particular hot-melt adhesive, for the formation of the spacers and supporting elements, respectively, but is also possible using prefabricated spacers and/or supporting elements which are inserted in or placed onto the filter material. Nor is the invention restricted to arrangements in which the inflow-side and outflow-side spacers and supporting elements, respectively, are completely aligned with each other over their entire width and/or length, but embraces also arrangements having only a partial positional overlapping.

The inventive element can be used in a particularly advantageous manner in air filters for fluidic arrangements, wherein relatively high alternating pressure loads are susceptible to arise, such as, for example, in internal combustion engines and here, in particular, gas turbines.

### LIST OF REFERENCE NUMERALS

| | |
|---|---|
| 11; 21; 31; 41; 51; 61 | filter element (“filter pack”) |
| 13; 23; 33; 53; 63 | filter material fleece (filter web) |
| 15; 25; 35; 45; 55; 65 | pleat wall |
| 15A, 15B; 25A, 25B; | |
| 35A, 35B; 45A, 45B | pleat edges |
| 17; 27; 37; 47; 57; 67 | elevations |
| 19A; 29A; 39A; 49A; | |
| 58A, 59A; 68A, 69A | first adhesive aggregates (spacers) |
| 19B; 29B; 39B; 49B; | |
| 59B; 68B, 69B | second adhesive aggregates (supporting elements) |
| A | inflow side |
| B | outflow side |

1. A filter element (11; 21; 31; 41; 51; 61) of a fluid filter, in particular of a cuboid or hollow-cylindrical outer shape, having an inflow side (A) and an outflow side (B) relative to a fluid to be filtered, with the filter element comprising a number of pleat walls (15; 25; 35; 45; 55; 65) each arranged in a continuous folding between pleat edges (15A; 15B; 25A; 25B, 35A; 35B; 45A; 45B), which pleat walls are comprised of a fluid-permeable filter material, in particular having impressed elevations (17; 27; 37; 47; 57; 67) constituting depressions on the other side of the filter material, and between adjacent pleat walls in each case on the inflow side (A), aggregates (19A; 29A; 39A; 49A; 58A, 59A; 68A, 69A) of hardened adhesive being provided on said elevations adhering to the pleat walls, which aggregates interconnect and support the pleat walls against each other, characterized in that
on the outflow side (B) and/or the inflow side (A) supporting elements (19B; 29B; 39B; 49B; 59B; 68B, 69B) are provided, the projection of which onto the plane of the adjacent pleat wall has a zone overlapping with the projections of the adhesive aggregates on the other pleat wall surface, in particular is situated in each case at least section-wise within the depressions.

2. The filter element according to claim 1, characterized in that
the projection of the supporting elements (19B; 29B; 39B; 49B; 59B; 68B, 69B) onto the plane of the pleat wall (15; 25; 35; 45; 55; 65) is situated essentially completely within the projection of the adhesive aggregates on the other pleat wall surface, in particular within depressions corresponding to the elevations (17; 27; 37; 47; 57; 67).

3. The filter element according to claim 1 or 2, characterized in that
the supporting elements (19B; 29B; 39B; 49B; 59B; 68B, 69B) are formed of hardened adhesive, in particular hot-melt adhesive, and each adhere to the two adjacent pleat walls (15; 25; 35; 45; 55; 65).

4. The filter element according to any one of the preceding claims, characterized in that
the adhesive aggregates and/or the supporting elements (19A, 19B; 29A, 29B; 39A, 39B; 49A, 49B; 58A, 58B; 68A, 68B; 69A, 69B) have an elongated shape and extend in each case over the larger part of the longitudinal extension of the adjacent pleat walls (15; 25; 35; 45).

5. The filter element according to claim 4, characterized in that
the adhesive aggregates and/or the supporting elements (19A; 29A; 39A, 39B) essentially extend over the entire length of the adjacent pleat wall (15; 25; 35).

6. The filter element according to any one of the preceding claims, characterized in that
the adhesive aggregates and/or the supporting elements (19A, 19B; 29A, 29B; 39A, 39B; 49A, 49B) are formed of two components, which are formed on the elevations (17; 27; 37; 47; 57; 67) and in the depressions, respectively, and which are molten with each other during folding of the filter material.

7. The filter element according to any one claims 3 through 6, characterized in that
the adhesive aggregates and supporting elements (19A, 19B; 29A, 29B; 39A, 39B; 49A, 49B; 58A, 58B; 68A, 68B; 69A, 69B) are configured having an increasing height into the direction of the respective opening zone of the pleat walls, whereas the optional elevations (17; 27; 37; 47) and depressions, respectively, of the pleat walls (15; 25; 35; 45) have an essentially constant height in the direction perpendicular to the pleat edges (15A, 15B; 25A, 25B; 35A, 35B; 45A, 45B).

8. The filter element according to any one of the preceding claims, characterized in that
the elevations (37) and depressions, respectively, are configured as essentially continuous impressed beads.

9. The filter element according to any one of the preceding claims, characterized in that
in the longitudinal direction following a pleat wall, an elevation portion intended for having an adhesive aggregate applied on the one side, and a depression portion for forming a supporting element on the other side, are realized.

10. The filter element according to any one of the preceding claims, characterized in that
the adhesive aggregates and/or supporting elements (29B) are configured as a plurality of isolated adhesive islands arranged in a row spaced apart in the longitudinal direction of the pleat walls (25), in particular having an increasing height in the opening direction of the pleat.

11. The use of a filter element according to any one of claims 1 through 9 as an air filter for a fluidic arrangement presenting an alternating pressure load, in particular a gas turbine.
